(19) United States
(12) Patent Application Publication
(10) Pub. No.: US 2020/0187528 A1
(43) Pub. Date: Jun. 18, 2020

(54) BEVERAGE POWDER

(71) Applicant: SOCIETE DES PRODUITS NESTLE S.A., Vevey (CH)

(72) Inventors: Cedric Dubois, Lavigny (CH); Marina Du pas-Lang let, Lavigny (CH); Lennart Fries, Belmont-sur-Lausanne (CH); Benjamin Le Reverend, Neuvecelle (FR); Vincent Daniel Maurice Meunier, Epalinges (CH)

(21) Appl. No.: 16/620,356

(22) PCT Filed: Jun. 6, 2018
(86) PCT No.: PCT/EP2018/064883

§ 371 Date: Dec. 6, 2019

(30) Foreign Application Priority Data
Jun. 7, 2017 (EP) 17174737.1

(51) Int. Cl. A23L 2/395; A23L 2/56; A23L 2/66; A23L 2/60; A23L 27/40; A23L 27/30; B65D 51/28

(52) U.S. Cl. CPC A23L 2/395; A23L 2/56; A23L 2/66; A23L 2/60; A23V 2002/00; A23L 27/35; A23L 27/40; B65D 51/2807; A23L 27/45

(57) ABSTRACT

The present invention relates to a beverage powder comprising water-soluble porous particles comprising a tastant, the particles being able to float on water. Further aspects of the invention are the use of a beverage powder to reduce the quantity of tastant in a beverage and a bottled beverage.

### FIELD OF THE INVENTION

The present invention relates to a beverage powder comprising water-soluble porous particles comprising a tastant, the particles being able to float on water. Further aspects of the invention are the use of a beverage powder to reduce the quantity of tastant in a beverage and a bottled beverage.

### BACKGROUND OF THE INVENTION

Soluble beverage powders provide a convenient way to quickly prepare a beverage such as a coffee or soup. Tastants such as sugar and salt are generally added to beverages to achieve the desired taste profile. The current trend is that consumers are more health conscious and are looking for healthier beverages with less sugar and less salt but without compromising the product taste.

### SUMMARY OF THE INVENTION

An object of the present invention is to improve the state of the art and to provide an improved solution to provide beverages with reduced levels of tastants such as sugar and salt. The object of the present invention is achieved by the subject matter of the independent claims. The dependent claims further develop the idea of the present invention.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

The present invention provides in a first aspect a beverage powder comprising water-soluble porous particles, the particles comprising a tastant and having an amorphous continuous phase comprising a soluble filler and optionally a surfactant, wherein the particles have a closed porosity of between 10 and 80% and can float in water. In a second aspect, the invention provides the use of a beverage powder comprising water-soluble porous particles to reduce the quantity of tastant in a beverage without adversely affecting the taste of the beverage, the particles comprising a tastant and having an amorphous continuous phase comprising a soluble filler and optionally a surfactant, wherein the particles have a closed porosity of between 10 and 80% and can float in water. In a further aspect, the invention provides a bottled beverage comprising; a) a container comprising an opening for receiving a closure, the container containing a liquid beverage; b) an ingredient release closure comprising a sealed compartment containing a beverage powder, a release mechanism for dispensing the beverage powder into said container; and attaching means for attaching to said opening of said container; c) said attaching means of said ingredient release closure attached to said opening of said container to form a bottled beverage; wherein said beverage powder comprises water-soluble porous particles which can float in water and which comprise a tastant.

Initial taste delivery is the main driver for overall taste perception. A beverage with more sugar in its surface layer will be perceived as sweeter than a beverage with the same overall sugar content but where the sugar is evenly distributed through the beverage. The inventors found that amorphous porous particles can be used to deliver tastants to the top of a beverage and so enhance the perception of that tastant. When porous particles with closed porosity are introduced to water, they rapidly float to the surface. The amorphous nature of the particles causes them to dissolve in the top region of the beverage creating a concentration gradient of the tastant.

### BRIEF DESCRIPTION OF THE DRAWINGS

FIG. 1 shows a scanning electron micrograph of a sample of the skimmed milk and sucrose amorphous porous particles formed in example 1. The particle has been fractured during preparation.

FIG. 2 is a plot of dissolution (%) (vertical axis) versus time (s) (horizontal axis) for porous amorphous powders with different compositions.

FIG. 3 is a plot of dissolution (%) (vertical axis) versus time (s) (horizontal axis) for amorphous powders with different levels of closed porosity.

FIG. 4a, 4b, 4c, 4d are synchrotron radiation X-ray tomographic microscopy images for amorphous powders.

FIG. 5 shows scanning electron micrographs of porous amorphous powders. I: sucrose/Nutriose®/sodium caseinate, J: sucrose/Nutriose®/pea protein, K: sucrose/lactose/pea protein, L: sucrose/Nutriose®/wheat gluten, and M: sucrose/Nutriose®/potato protein.

FIG. 6 shows scanning electron micrographs of porous amorphous powders with sucrose, maltodextrin, and N: spelt milk, O: coconut milk, P: oat milk, O: almond milk, R: rice milk and S: soya milk.

FIG. 7 shows the dissolution rates of porous amorphous powders. Sucrose and skimmed milk (B), lactose and pea (K), Nutriose® and wheat gluten (L), maltodextrin and almond milk (Q), maltodextrin and coconut milk (O) and maltodextrin and soya milk (S).

FIG. 8 is a schematic representation of the apparatus to measure tastant gradient on dissolution. Four refractive index probes numbered P1 (bottom) to P4 (top) fixed in a beaker.

FIG. 9 shows a plot of sugar concentration at four heights in a beaker during dissolution of powder B, briefly stirred forcefully.

FIG. 11 shows a plot of sugar concentration at four heights in a beaker during dissolution of amorphous porous particles with partially aggregated protein from Example 8, careful stirring.

FIG. 12 shows a plot of sugar concentration at four heights in a beaker during dissolution of powder B, careful stirring.

### DETAILED DESCRIPTION OF THE INVENTION

Consequently the present invention relates in part to a beverage powder comprising water-soluble porous particles, the particles comprising a tastant and having an amorphous continuous phase comprising a soluble filler and optionally a surfactant, wherein the particles have a closed porosity of between 10 and 80% and can float in water. In the context of the present invention the term beverage powder refers to a powder that is to be combined with an aqueous composition (for example water) to prepare a beverage. The beverage powder may not necessarily contain all the non-aqueous components of the final beverage. Particles which can float in water may be for example particles having an apparent density less than the density of water.

A tastant is a substance that stimulates the sense of taste. The sensation of taste includes five established basic tastes: sweetness, sourness, saltiness, bitterness, and umami. In the context of the present invention, the term taste is distinct from aroma (detected by the nose) and flavour, of which taste and aroma are components. The particles comprising a tastant may further comprise an aroma. The tastant according to the invention may provide a taste selected from the group consisting of sweet, salty and umami, for example the tastant may be sweet or salty.

An aspect of the invention is a beverage powder comprising water-soluble porous particles, the particles comprising an aroma and having an amorphous continuous phase comprising a soluble filler and optionally a surfactant, wherein the particles have a closed porosity of between 10 and 80% and can float in water.

According to the present invention the term ‘amorphous’ as used herein is defined as being a glassy solid, essentially free of crystalline material.

According to the present invention the term glass transition temperature (Tg) as used herein is to be interpreted as is commonly understood, as the temperature at which an amorphous solid becomes soft upon heating. The glass transition temperature is always lower than the melting temperature (Tm) of the crystalline state of the material. An amorphous material can therefore be conventionally characterised by a glass transition temperature, denoted Tg. A material is in the form of an amorphous solid (a glass) when it is below its glass transition temperature.

Several techniques can be used to measure the glass transition temperature and any available or appropriate technique can be used, including differential scanning calorimetry (DSC) and dynamic mechanical thermal analysis (DMTA)

In an embodiment of the present invention the amorphous continuous phase of the porous particles according to the invention is characterised as having a glass transition temperature of at least 40° C. or higher, preferably at least 50° C. or higher and more preferably at least 60° C. or higher.

Advantageously in contrast to prior art solutions, the amorphous continuous phase of the porous particles according to the present invention is less hygroscopic making such material easier to handle and store.

According to the present invention the term porous as used herein is defined as having multiple small pores, voids or interstices, for example of such a size to allow air or liquid to pass through. In the context of the present invention porous is also used to describe the aerated nature of the particles according to the present invention.

In the present invention the term porosity as used herein is defined as a measure of the empty spaces (or voids or pores) in a material and is a ratio of the volume of voids to total volume of the mass of the material between 0 and 1, or as a percentage between 0 and 100%

Porosity can be measured by means known in the art. For instance, the particle porosity can be measured by the following equation:

Porosity=Vp−Vcm/Vp×100

wherein Vp is the Volume of the particle and Vcm is the volume of the matrix or bulk material.

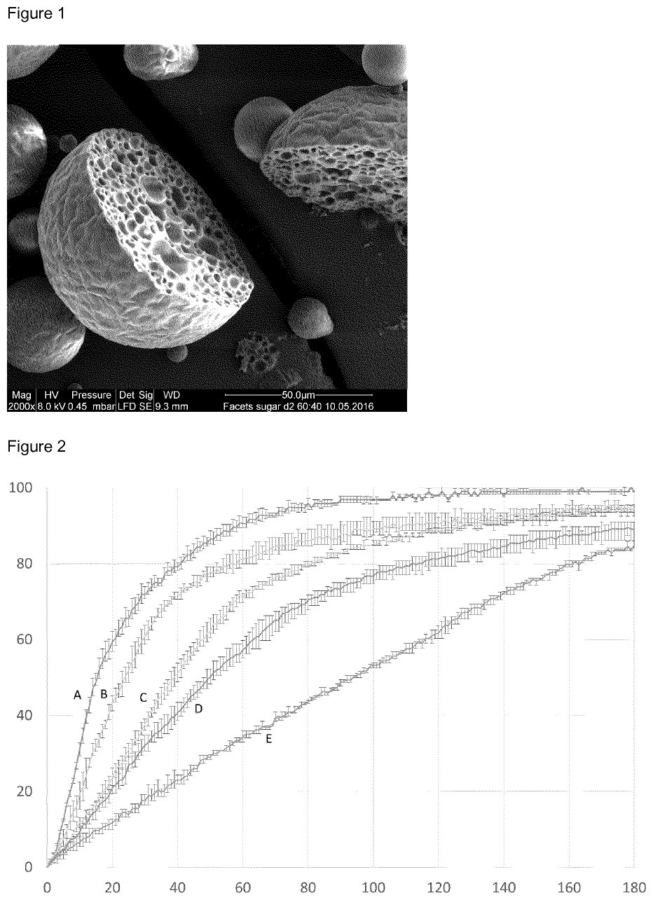

According to the present invention the term closed or internal porosity as used herein refers in general terms to the total amount of void or space that is trapped within the solid. As can be seen in FIG. 1, porous particles according to the present invention show an internal micro structure wherein the voids or pores are not connected to the outside surface of the said particles. In the present invention the term closed porosity is further defined as the ratio of the volume of closed voids or pores to the particle volume.

The tastant according to the invention may be a sweet tastant such as sugar, for example sucrose. A potential problem when producing a reduced sugar version of an existing beverage powder is that the reduction in sugar leads to a reduction in serving volume, for example when a high intensity sweetener is introduced as full or partial replacement of sucrose. Consumers may be confused by the change in the volume of powder that is needed to make a good tasting beverage, indeed they may continue to use the same volume, for example the same measuring spoon, resulting in using too much powder. Having porous particles in the powder, the volume of powder required to make a good tasting beverage can be maintained for the sugar-reduced product.

Increasing the porosity of the amorphous particles increases their dissolution speed in water (see Example 2). For best result, the particles according to the invention should rapidly rise to the surface, but then dissolve fast enough to create a tastant gradient in the reconstituted beverage before it is consumed. Closed porosity aids buoyancy. Porosity also increases dissolution speed. However, increasing the porosity of the particles increases their fragility. It is advantageous that the porous amorphous particles of the present invention exhibit closed porosity. Particles with closed porosity, especially those with many small spherical pores, are more robust than particles with open pores, as the spherical shapes with complete walls distribute any applied load evenly.

The porous particles comprised within the beverage powder of the invention may have a closed porosity of between 10 to 80%, for example between 15 and 70%, for further example between 20 and 60%.

It is advantageous to have multiple small closed pores in the particles according to the invention. Taking the extreme case of a soluble porous particle with one large internal pore, when such a particle is contacted with water it only requires one breach of the outer wall for the particle to fill with water and lose buoyancy. A particle with multiple small closed pores will retain its buoyancy for longer as it dissolves, and so has the capability to rise to the top of a beverage and form a concentration gradient of tastant. For a given particle size and porosity, increasing the number of pores within the particles is reflected by an increased normalized specific surface. The porous particles comprised within the beverage powder of the invention may have a normalized specific surface of between 0.10 and 0.18 m⁻¹, for example between 0.12 and 0.17 m⁻¹. The porous particles comprised within the beverage powder of the invention may have a normalized specific surface of between 0.10 and 0.18 m⁻¹ (for example between 0.12 and 0.17 m⁻¹) and a particle size distribution D90 of between 30 and 60 μm.

$$Normalized specific surface = \frac{\begin{matrix}interstitial surface area of pores + \\ external surface area of material\end{matrix}}{solid volume of material}$$

According to the present invention the term density is the mass per unit volume of a material. For porous powder, three terms are commonly used; apparent density, tap density and absolute density. Apparent density (or envelope density) is the mass per unit volume wherein pore spaces within particles are included in the volume. Tap density is the density obtained from filling a container with the sample material and vibrating it to obtain near optimum packing. Tap density includes inter-particle voids in the volume whereas apparent density does not. In absolute density (or matrix density), the volume used in the density calculation excludes both pores and void spaces between particles.

In an embodiment of the present invention the porous particles comprised within the beverage powder of the invention have an apparent density of between 0.3 to 1.0, for example 0.5 to 0.9.

D90 values and D_{4,3} values are common methods of describing a particle size distribution. The D90 (sometimes written d₉₀) is the diameter where 90% of the mass of the particles in the sample have a diameter below that value. In the context of the present invention the D90 by mass is equivalent to the D90 by volume. The term “D_{4,3} particle size” is used conventionally in the present invention and is sometimes called the volume mean diameter. The D90 value and D_{4,3} values may be measured for example by a laser light scattering particle size analyser. Other measurement techniques for particle size distribution may be used depending on the nature of the sample. For example, the D90 value of powders may conveniently be measured by digital image analysis (such as using a Camsizer XT).

The porous particles comprised within the beverage powder of the invention may have a particle size distribution D90 below 450 microns, for example below 140 microns, for further example between 30 and 140 microns. The porous particles comprised within the beverage powder of the invention may have a particle size distribution D90 of less than 90 microns, for example less than 80 microns, for further example less than 70 microns. The porous particles comprised within the beverage powder of the invention may have a particle size distribution D90 of between 40 and 90 microns, for example between 50 and 80 microns.

The porous particles comprised within the beverage powder of the invention may be approximately spherical, for example they may have a sphericity of between 0.8 and 1. Alternatively, the particles may be non-spherical, for example they may have been refined, for example by milling.

The porous particles comprised within the beverage powder of the invention may be obtained by foam drying, freeze drying, tray drying, fluid bed drying and the like. Preferably the porous particles comprised within the beverage powder of the invention are obtained by spray drying with pressurized gas injection.

The spray in a spray drier produces droplets that are approximately spherical and can be dried to form approximately spherical particles. However, spray driers are typically set to produce agglomerated particles, as agglomerated powders provide advantages as ingredients in terms of flowability and lower dustiness, for example an open top spray drier with secondary air recirculation will trigger particle agglomeration. The agglomerated particles may have a particle size distribution D90 of between 120 and 450 μm. The size of spray-dried particles with or without agglomeration may be increased by increasing the aperture size of the spray-drying nozzle (assuming the spray-drier is of sufficient size to remove the moisture from the larger particles). The porous particles comprised within the beverage powder of the invention may comprise un-agglomerated particles, for example at least 80 wt. % of the amorphous porous particles comprised within the composition of the invention may be un-agglomerated particles. The porous particles comprised within the beverage powder of the invention may be agglomerated particles which have been refined.

When formed into agglomerates, the agglomerated particles generally retain convex rounded surfaces composed of the surfaces of individual spherical particles. Refining spherical or agglomerated spherical particles causes fractures in the particles which leads to the formation of non-rounded surfaces. The refined particles according to the invention may have less than 70% of their surface being convex, for example less than 50%, for further example less than 25%.

The soluble filler increases the particle volume and hence the amount of gas which may be contained within the porous particles. The soluble filler also aids the formation and stability of an amorphous phase. The soluble filler according to the beverage powder of the invention may be a biopolymer, for example a sugar alcohol, saccharide oligomer or polysaccharide. The soluble filler may be a polysaccharide. In an embodiment, the porous particles according to the beverage powder of the present invention comprise a soluble filler in the amount of 5 to 70%, for example 10 to 40%, for further example 10 to 30%, for still further example 40 to 70%. According to the beverage powder of the present invention the soluble filler may be selected from the group consisting of sugar alcohols (for example isomalt, sorbitol, maltitol, mannitol, xylitol, erythritol and hydrogenated starch hydrolysates), lactose, maltose, fructo-oligosaccharides, alpha glucans, beta glucans, starch (including modified starch), natural gums, dietary fibres (including both insoluble and soluble fibres), polydextrose, methylcellulose, maltodextrins, inulin, dextrins such as soluble wheat or corn dextrin (for example Nutriose®), soluble fibre such as Promitor® and any combination thereof.

In an embodiment of the present invention the soluble filler may be selected from the group consisting of lactose, maltose, maltodextrins, soluble wheat or corn dextrin (for example Nutriose®), polydextrose, soluble fibre such as Promitor® and any combinations thereof.

The porous particles comprised within the beverage powder of the invention may comprise a tastant, a soluble filler and a surfactant, all distributed throughout the continuous solid phase of the particles. Higher concentrations of surfactant may be present at the gas interfaces than in the rest of the continuous phase, but the surfactant is in the continuous phase inside the particles, not just coated onto the exterior. For example, the surfactant may be present in the interior of the particles according to the beverage powder of the invention.

The tastant according to the invention may be a sweetener. In the present invention the term sweetener refers to substance which provides a sweet taste. The sweetener may be a sugar, for example a mono, di or oligo-saccharide. The sweetener may be selected from the group consisting of sucrose, fructose, glucose, dextrose, galactose, allulose, maltose, high dextrose equivalent hydrolysed starch syrup, xylose, and combinations thereof. Accordingly, the sweetener comprised within the amorphous continuous phase of the particles according to the invention may be selected from the group consisting of sucrose, fructose, glucose, dextrose, galactose, allulose, maltose, high dextrose equivalent hydrolysed starch syrup xylose, and any combinations thereof. The sweetener may be sucrose.

In a preferred embodiment the amorphous continuous phase of the particles according to the invention comprises sweetener (for example sucrose) in the amount of 5 to 70%, preferably 10 to 50%, even more preferably 20 to 40%.

Without being bound by theory it is believed that particles comprising sweetener (for example sugar) in the amorphous state provide a material which dissolves more rapidly than crystalline sugar particles of a similar size.

The porous particles comprised within the beverage powder of the present invention may have a moisture content between 0.5 and 6 wt. %, for example between 1 and 5 wt. %, for further example between 1.5 and 3 wt. %.

In an embodiment, the amorphous continuous phase of the particles according to the invention comprise a colloid stabilizer, for example a foam stabilizer. The colloid stabilizer may be a finely divided solid stabilizing a foam by the Pickering effect. The colloid stabilizer may be particles of protein. The colloid stabilizer may be partially aggregated proteins. The colloid stabilizer may be a surfactant. To form the amorphous continuous phase of the particles an aqueous solution may be dried or cooled to form a glass. A colloid stabilizer aids the formation of porosity.

In an embodiment, the amorphous continuous phase of the particles of the present invention comprises a surfactant, the surfactant being plant protein or dairy protein. In an embodiment, the amorphous continuous phase of the particles of the present invention comprises a surfactant in the amount of 0.5 to 15 wt. %, for example 1 to 10 wt. %, for further example 1 to 5 wt. %, for further example 1 to 3 wt. %. The surfactant may be selected from the group consisting of lecithin, whey proteins, milk proteins, non-dairy proteins, sodium caseinate, lysolecithin, fatty acid salts, lysozyme, sodium stearoyl lactylate, calcium stearoyl lactylate, lauroyl arginate, sucrose monooleate, sucrose monostearate, sucrose monopalmitate, sucrose monolaurate, sucrose distearate, sorbitan monooleate, sorbitan monostearate, sorbitan monopalmitate, sorbitan monolaurate, sorbitan tristearate, PGPR, PGE and any combinations thereof. For example, the surfactant may be sodium caseinate or lecithin.

It should be noted that soluble fillers derived from milk powder such as skimmed milk powder inherently comprise the surfactant sodium caseinate. Whey powder contains whey protein.

The surfactant comprised within the amorphous continuous phase of the particles according to the present invention may be a non-dairy protein. In the context of the present invention the term “non-dairy proteins” refers to proteins that are not found in bovine milk. The primary proteins in bovine milk are caseins and whey proteins. Some consumers desire to avoid milk proteins in their diets, for example they may suffer from milk protein intolerance or milk allergy and so it is advantageous to be able to offer food products free from dairy proteins. The surfactant comprised within the amorphous continuous phase of the particles of the present invention may be selected from the group consisting of pea proteins, almond proteins, coconut proteins, potato proteins, wheat gluten, egg albumin proteins (for example ovalbumin, ovotransferrin, ovomucoid, ovoglobulin, ovomucin and/or lysozyme), clupeine, oat protein, soy proteins, tomato proteins, Brassicaceae seed protein and combinations of these. For example the surfactant comprised within the particles of the invention may be selected from the group consisting of pea proteins, potato proteins, wheat gluten, soy proteins, and combinations of these. For further example the surfactant comprised within the particles of the invention may be selected from the group consisting of coconut protein, almond protein, wheat gluten, and combinations of these. The surfactant comprised within the particles of the invention may be coconut or almond protein.

In an embodiment, the amorphous continuous phase of the particles according to the present invention may comprise a non-dairy protein in the amount of 0.5 to 15%, preferably 1 to 10%, more preferably 1 to 5%, even more preferentially 1 to 3%.

Some consumers wish to avoid dairy products in their diet. In an embodiment, the amorphous continuous phase of the particles according to the present invention may be free from milk ingredients. For example, the amorphous continuous phase of the particles according to the present invention may comprise sucrose; a bulking agent selected from the group consisting of maltose, maltodextrins, soluble wheat or corn dextrin, polydextrose, soluble fibre and combinations of these; and a surfactant selected from the group consisting of pea proteins, potato proteins, wheat gluten, egg albumin proteins, clupeine, soy proteins, oat protein, tomato proteins, Brassicaceae seed protein and combinations of these.

In an embodiment, the beverage powder of the invention may comprise partially aggregated proteins, for example the porous particles according to the beverage powder of the invention may comprise partially aggregated proteins. In an embodiment of the invention, partially aggregated proteins may be dispersed in the amorphous continuous phase of the porous particles. The partially aggregated proteins may comprise proteins selected from the group consisting of soy proteins (for example soy glycinin, for further example conglycinin), egg proteins (for example ovalbumin, for further example ovaglobulins), rice proteins, almond proteins, oat proteins, pea proteins, potato proteins, wheat proteins (for example gluten), milk proteins (for example whey protein, for further example casein) and combinations of these. The proteins may have been partially aggregated by the application of shear, for example processing a protein solution or suspension in a high shear mixer for at least 15 minutes. The proteins may have been partially aggregated by a heat treatment at a temperature between 65° C. and 100° C. for a period of between 50 seconds and 90 minutes at a pH of between 5.5 and 7.1. The higher the temperature applied the shorter the time required to reach partial aggregation. Heating for too long should be avoided as this fully denatures the proteins leading to them precipitating out as insoluble particles. In an embodiment, the proteins have been partially aggregated by a heat treatment at a temperature between 90° C. and 100° C. for a period of between 30 seconds and 3 minutes at a pH of between 5.5 and 7.1. In an embodiment, the proteins have been partially aggregated by a heat treatment at a temperature between 65° C. and 75° C. for a period of between 10 minutes and 30 minutes at a pH of between 5.5 and 7.1. The process conditions described provide clumps of partially agglomerated proteins with a size small enough to pass through a spray nozzle (for example during spray-drying), but still provide a positive impact on the mouthfeel of the beverage according to the invention. The partially aggregated proteins may be in the form of protein aggregates dispersed within the amorphous porous particles. The beverage powder of the invention may comprise between 1 and 30 wt. % partially aggregated proteins. The partially aggregated proteins may have a D_{4,3} particle size of between 1 and 30 μm. The partially aggregated proteins create or enhance a creamy mouthfeel in the beverage.

In an embodiment, the beverage powder of the invention comprises partially aggregated milk proteins, for example the porous particles according to the beverage powder of the invention may comprise partially aggregated milk proteins. The partially aggregated milk proteins may be whey-protein and casein; the weight ratio of whey-protein:casein may be from 0.3-0.5. In the context of the current invention the term “milk” refers to mammalian milk, for example milk from cows, sheep or goats. The milk according to embodiments of the present invention may be cows' milk.

“Whey protein” is a mixture of globular proteins isolated from whey. It is a typical by-product of the cheese making process. “Casein” pertains to a family of related phospho-proteins commonly found in mammalian milk, i.e. αs1-, αs2-, β- and κ-caseins. They make up about 80% of the proteins in cows' milk and are typically the major protein component of cheese. The “ratio” or “weight ratio” of whey-protein versus casein protein (i.e. whey-protein:casein) is defined in the present invention as the ratio of the weights (i.e. dry weights) of those respective proteins to each other.

In an embodiment of the invention wherein the beverage powder of the invention comprises partially aggregated milk proteins, the partially aggregated milk proteins may be prepared from an aqueous composition comprising whole milk or skimmed milk, for example by adjusting the pH of the aqueous composition to a value between 5.8 and 6.3 (for example between 6.0 and 6.1) and heating to a temperature of between 85 and 100° C. (for example between 90 and 100° C.) for between 50 seconds and 10 minutes (for example between 3 and 7 minutes).

In an embodiment of the invention wherein the beverage powder of the invention comprises partially aggregated milk proteins, the partially aggregated milk proteins may be whey-protein and casein (for example micellar casein). The casein to whey protein ratio may be from 90/10 to 60/40. Divalent cations such as calcium or magnesium cations may be used in the formation of the partially aggregated protein.

In an embodiment, the beverage powder of the invention comprises partially aggregated non-dairy proteins, for example the porous particles according to the beverage powder of the invention may comprise partially aggregated non-dairy proteins. The non-dairy proteins may be selected from the group consisting of soy, egg, rice, almond and wheat protein. The partially aggregated non-dairy proteins may be prepared from an aqueous composition comprising non-dairy proteins by adjusting the pH of the aqueous composition to a pH value between 5.8 and 6.1 and heating to a temperature of between 65 and 95° C. (for example between 68° C. and 93° C.) for between 3 and 90 minutes.

In an embodiment, the partially aggregated proteins may comprise (for example consist of) at least two proteins selected from the group consisting of soy proteins, egg proteins, rice proteins, almond proteins, oat proteins, pea proteins, potato proteins, wheat proteins, casein, whey proteins and combinations of these. The partially aggregated proteins may comprise (for example consist of) milk proteins and soy proteins. The partially aggregated proteins may comprise (for example consist of) milk proteins and pea proteins. The partially aggregated proteins may comprise (for example consist of) milk proteins and potato proteins. The partially aggregated proteins may comprise (for example consist of) pea proteins and soy proteins. The partially aggregated proteins may comprise (for example consist of) pea proteins and potato proteins.

In the context of the present invention the term partially aggregated proteins means that a proportion of the proteins have been aggregated. The content of soluble protein after the aggregation process is preferably below or equal to 30%, preferably below or equal to 20% in relation to the total protein content; the majority of the proteins being embedded in aggregated structures. Partially aggregated particles are able to form networks. Partially aggregated proteins can bind or entrap water and fat particles to increase viscosity and mouthfeel. Partially aggregated particles are distinct from insoluble protein particles for example protein precipitates.

The amorphous continuous phase of the particles according to the present invention may comprise (for example consist on a dry basis of) sucrose and skimmed milk. The sucrose may be present at a level of at least 30 wt. % in the particles. The ratio of sucrose to skimmed milk may be between 0.5 to 1 and 2.5 to 1 on a dry weight basis, for example between 0.6 to 1 and 1.5 to 1 on a dry weight basis. The skimmed milk may have a fat content below 1.5 wt. % on a dry weight basis, for example below 1.2 wt. %. The components of skimmed milk may be provided individually and combined with sucrose, for example the amorphous continuous phase of the particles according to the present invention may comprise sucrose, lactose, casein and whey protein. Sucrose and skimmed milk provide an amorphous porous particle which has good stability against recrystallization without necessarily requiring the addition of reducing sugars or polymers. For example the amorphous continuous phase of the particles according to the present invention may be free from reducing sugars (for example fructose, glucose or other saccharides with a dextrose equivalent value. The dextrose equivalent value may for example be measured by the Lane-Eynon method). For further example the amorphous continuous phase of the particles according to the present invention may be free from oligo- or polysaccharides having a three or more saccharide units, for example maltodextrin or starch.

The amorphous continuous phase of the particles according to the present invention may comprise sucrose, lactose and caseinate, for example amorphous continuous phase of the particles according to the present invention may comprise sucrose and skimmed milk. The amorphous continuous phase of the particles according to the present invention may comprise sucrose, lactose and whey protein, for example amorphous continuous phase of the particles according to the present invention may comprise sucrose and whey (for example sweet whey). The amorphous continuous phase of the particles according to the present invention may comprise sucrose, lactose, partially aggregated milk protein and optionally milk fat. Sucrose may be present at a level of at least 30 wt. % in the particles.

The amorphous continuous phase of the particles according to the present invention may comprise sucrose, maltodextrin (for example a maltodextrin with a DE between 12 and 20), and a protein selected from the group consisting of almond protein, coconut protein, spelt protein, soy protein and wheat protein. The amorphous continuous phase of the particles according to the present invention may comprise sucrose, maltodextrin (for example a maltodextrin with a DE between 12 and 20), and a partially aggregated protein, the protein being obtained from a source selected from the group consisting of egg, rice, almond, wheat and combinations of these. The sucrose may be present at a level of at least 30 wt. % in the particles.

The beverage powder of the invention may comprise plant milks. For example the amorphous continuous phase of the particles according to the invention may comprise plant milk. In an embodiment, the amorphous continuous phase of the particles comprises a plant milk selected from the group consisting of almond milk, oat milk, spelt milk, coconut milk, soy milk and rice milk. For example, the amorphous continuous phase of the particles may comprise almond milk. Plant milk is typically produced by grinding the plant material with water and then straining out the solid material. Plant milks may already contain appropriate qualities and quantities of soluble filler to form an amorphous material on drying, but additional soluble fillers may be added to form the particles according to the invention. For example, soluble fillers may be added to increase the glass transition temperature of the amorphous porous particles. The amorphous continuous phase of the particles according to the present invention may comprise a tastant, a plant milk and a soluble filler selected from the group consisting of maltodextrin (for example a maltodextrin with a DE between 12 and 20), soluble fibre and lactose. The amorphous continuous phase of the particles according to the present invention may comprise sucrose (for example at a level of at least 30 wt. % in the particles), a soluble filler and a plant milk. For example the amorphous continuous phase of the particles according to the present invention may comprise sucrose (for example at a level of at least 30 wt. % in the particles), a soluble filler (for example maltodextrin) and almond milk. In an embodiment the amorphous continuous phase of the porous particles according to the beverage powder of the invention comprises sucrose, maltodextrin and almond protein.

In an embodiment, the tastant according to the invention may be a salty tastant, for example a tastant comprising sodium chloride and/or potassium chloride. A beverage powder according to the invention comprising a salty tastant allows the total amount of salt in a beverage such as a soup to be reduced. Salt is delivered to the top of the beverage by the buoyant porous particles which then dissolve. The resulting concentration gradient in the beverage enhances its salty taste. The salty tastant may be present in the particles according to the invention at a level of between 0.5 wt. % and 30 wt. %, for example between 1 wt. % and 20 wt. %, for further example between 2 wt. % and 10 wt. %. Sodium chloride or potassium chloride may be present in the amorphous continuous phase of the porous particles according to the invention as dissociated ions. In an embodiment, the amorphous continuous phase of the porous particles comprises maltodextrin, caseinate and dissociated sodium or potassium chloride.

An aspect of the invention provides the use of a beverage powder to reduce the quantity of tastant in a beverage without adversely affecting the taste of the beverage. For example the use of a beverage powder to reduce the quantity of tastant in a beverage without adversely affecting the taste of the beverage wherein the beverage powder comprises water-soluble porous particles, the particles comprising a tastant and having an amorphous continuous phase comprising a soluble filler and optionally a surfactant, wherein the particles have a closed porosity of between 10 and 80% and can float in water. The beverage powder may be selected from the group consisting of instant coffee mix (for example comprising coffee, milk and sugar), a flavoured milk powder, an instant cocoa beverage, an instant malted beverage and a powdered soup. The beverage powder may be for use in beverage preparation machines, for example beverage vending machines.

In an embodiment, the invention provides the use of a beverage powder to reduce the quantity of tastant in a beverage without adversely affecting the taste of the beverage wherein the beverage powder comprises water-soluble porous particles, the particles having an amorphous continuous phase comprising sucrose and skimmed milk, and wherein the particles have a closed porosity of between 10 and 80% and can float in water. The sucrose may be present at a level of at least 30 wt. % in the particles. The ratio of sucrose to skimmed milk may be between 0.5 to 1 and 2.5 to 1 on a dry weight basis, for example between 0.6 to 1 and 1.5 to 1 on a dry weight basis.

In a further embodiment, the invention provides the use of a beverage powder to reduce the quantity of tastant in a beverage without adversely affecting the taste of the beverage wherein the beverage powder comprises water-soluble porous particles, the particles having an amorphous continuous phase comprising sucrose, maltodextrin (for example a maltodextrin with a DE between 12 and 20), and a protein selected from the group consisting of almond protein, coconut protein, spelt protein, soy protein, rice protein and oat protein, and wherein the particles have a closed porosity of between 10 and 80% and can float in water. For example the invention may provide the use of a beverage powder to reduce the quantity of tastant in a beverage without adversely affecting the taste of the beverage wherein the beverage powder comprises water-soluble porous particles, the particles having an amorphous continuous phase comprising sucrose, maltodextrin (for example a maltodextrin with a DE between 12 and 20) and almond protein, and wherein the particles have a closed porosity of between 10 and 80% and can float in water.

In a further embodiment, the invention provides the use of a beverage powder to reduce the quantity of tastant in a beverage without adversely affecting the taste of the beverage wherein the beverage powder comprises water-soluble porous particles, the particles having an amorphous continuous phase comprising sucrose, soluble fibre and a protein selected from the group consisting of pea protein, wheat protein and potato protein, and wherein the particles have a closed porosity of between 10 and 80% and can float in water.

In a further embodiment, the invention provides the use of a beverage powder to reduce the quantity of tastant in a beverage without adversely affecting the taste of the beverage wherein the beverage powder comprises water-soluble porous particles, the particles having an amorphous continuous phase comprising sucrose, soluble fibre and a sodium caseinate, and wherein the particles have a closed porosity of between 10 and 80% and can float in water.

In a further embodiment, the invention provides the use of a beverage powder to reduce the quantity of tastant in a beverage without adversely affecting the taste of the beverage wherein the beverage powder comprises water-soluble porous particles, the particles having an amorphous continuous phase comprising sucrose and partially aggregated proteins selected from the group consisting of soy proteins, egg proteins, rice proteins, almond proteins, oat proteins, pea proteins, potato proteins, wheat proteins, milk proteins and combinations of these, and wherein the particles have a closed porosity of between 10 and 80% and can float in water.

The beverage powder may be provided in a portioned pack such as a sachet. The consumer is able to add the beverage powder from the sachet to a bottle of water. The beverage powder may be stored within the closure (for example the cap) of a beverage bottle such as a bottle containing water. The beverage powder may be added manually to the water just before consumption, or the closure can be arranged to add the powder to the water as the bottle is opened. Accordingly, in one aspect, the invention provides a bottled beverage comprising; a) a container comprising an opening for receiving a closure, the container containing a liquid beverage; b) an ingredient release closure comprising a sealed compartment containing a beverage powder, a release mechanism for dispensing the beverage powder into said container; and attaching means for attaching to said opening of said container; c) said attaching means of said ingredient release closure attached to said opening of said container to form a bottled beverage; d) wherein said beverage powder comprises water-soluble porous particles which can float in water and which comprise a tastant. The tastant comprised within the beverage powder may be absent from the liquid beverage. The water soluble porous particles may have an amorphous continuous phase comprising a soluble filler and optionally a surfactant. The water soluble porous particles may have a closed porosity of between 10 and 80%.

The beverage powder of the present invention may be free from ingredients not commonly used by consumers when preparing food in their own kitchen, in other words, the beverage powder of the present invention may consist of so-called “kitchen cupboard” ingredients.

Those skilled in the art will understand that they can freely combine all features of the present invention disclosed herein. In particular, features described for the product of the present invention may be combined with the process of the present invention and vice versa. Further, features described for different embodiments of the present invention may be combined. Where known equivalents exist to specific features, such equivalents are incorporated as if specifically referred to in this specification.

Further advantages and features of the present invention are apparent from the figures and non-limiting examples.

### EXAMPLES

Determination of Glass Transition Temperature

Glass transition temperatures (Tg) were measured by Differential Scanning Calorimetry (TA Instrument Q2000). A double scan procedure was used to erase the enthalpy of relaxation and get a better view on the glass transition. The scanning rate was 5° C./min. The first scan was stopped approximately 30° C. above Tg. The system was then cooled at 20° C./min. The glass transition was detected during the second scan and defined as the onset of the step change of the heat capacity.

Determination of Structures Using Cryo-Scanning Electron Microscopy

Cryo-Scanning Electron Microscopy (Cryo-SEM) and X-ray Tomography (μCT) are used to investigate the microstructure of the amorphous porous particles of the present invention within a fat based food matrix.

A 1 cm³ piece of sample was glued into a Cryo-SEM sample holder using TissueTek. It was rapidly frozen in slushy nitrogen prior to its transfer into the cryo-preparation unit Gatan Alto 2500 at −170° C. The frozen sample was fractured using a cooled knife, making its internal structure accessible. The fracture was not performed when the external surface of the chocolate was analyzed. A slight etching of superficial water was performed in the preparation unit for 15 min at −95° C., followed by sample stabilization at −120° C. A final coating was done by an application of a 5 nm platinum layer onto the surface. For visualization a FEI Quanta 200 FEG at 8 kV in high vacuum mode was used.

Determination of Sphericity

Sphericity was measured by the Camsizer XT. It is an opto-electronic instrument, allowing the measurement of the size and shape parameters of powders, emulsions and suspensions. The technique of digital image analysis is based on the computer processing of a large number of sample's pictures taken at a frame rate of 277 images/seconds by two different cameras, simultaneously. The sample is lightened by two pulsed LED light sources during the measurement. Particle size and particle shape (including sphericity) are analyzed with a user-friendly software which calculates the respective distribution curves in real time. The perimeter of a particle projection and the covered area were measured to obtain the sphericity.

### Example 1: Preparation of Amorphous Porous Particles

| Ingredients | Amount (wt %) |
|---|---|
| water | 50 |
| Sucrose | 60 |
| Skimmed milk powder | 40 |

All ingredients were weighed separately and then mixed with a polytron PT3000D mixer until full dissolution at room temperature with a speed rate between 6000 and 12000 rpm. The inlet solution is transferred in a vessel at controlled temperature of 55° C. and is then pumped at 100-130 bar. High pressure nitrogen is injected at 0.5-2 NL/min for at least 10 mins or a least until full dissolution of the gas in the solution is achieved. After a pre-heating at 60 deg C., the solution is spray-dried using a one-stream closed-top spray drier according to the parameters listed in the table below:

Spray-drying parameters

| Nozzle | Alphanumeric (diameter 0.35) | |
|---|---|---|
| Inlet air temperature | 120 | deg C. |
| Output temperature | 85 | deg C. |
| Drying air volume | 400 | m3 |
| Pump pressure | 130 | bars |
| Gas injection | 0.5-2 | NL/min |
| Solution flowrate | 12 | L/h |

Amorphous porous particles were obtained having an internal structure with closed porosity, see micrograph FIG. 1. The powder contained 2.17 wt. % moisture, had a closed porosity of 50.3%, a D90 of 46.3 microns and a Tg of 52.1° C. Measured sphericity values were between 0.85 and 0.89.

### Example 2: Effect of Porosity and Composition

The effect of altering porosity and composition on dissolution speed was investigated.

Amorphous porous particles were prepared as in Example 1, with the inlet solution containing 50 wt. % water and 50 wt. % of sucrose+SMP (skimmed milk powder) at the appropriate ratio. No sodium caseinate was added as this is already present in SMP. Particle size distribution was measured using a Camsizer XT (Retsch Technology GmbH, Germany).

| | Ratio | Closed | Particle size |
|---|---|---|---|
| Powder | sucrose:SMP | porosity | distribution D90 |
| A | 70:30 | 50% | 50 μm |
| B | 60:40 | 53% | 53 μm |
| C | 50:50 | 51% | 52 μm |
| D | 40:60 | 57% | 60 μm |
| E | 30:70 | 60% | 55 μm |

Samples with different levels of porosity, but with similar particle size distributions and the same composition were prepared. Sample G was prepared with no gas injection. This produced a very low level of closed porosity (6%). Varying the gas flow up to 2 normal litres per minute allowed increasing levels of closed porosity to be generated.

| | Ratio | Closed | Particle size |
|---|---|---|---|
| Powder | sucrose:SMP | porosity | distribution D90 |
| A | 70:30 | 50% | 50 μm |
| F | 70:30 | 33% | 41 μm |
| G | 70:30 | 6% | 40 μm |

The closed porosity was obtained by measuring the matrix and apparent densities.

The matrix density was determined by DMA 4500 M (Anton Paar, Switzerland AG). The sample was introduced into a U-shaped borosilicate glass tube that is excited to vibrate at its characteristic frequency which depends on the density of the sample. The accuracy of the instrument is 0.00005 g/cm³ for density and 0.03° C. for temperature.

The apparent density of powders was measured by Accupyc 1330 Pycnometer (Micrometrics Instrument Corporation, US). The instrument determines density and volume by measuring the pressure change of helium in a calibrated volume with an accuracy to within 0.03% of reading plus 0.03% of nominal full-scale cell chamber volume.

Closed porosity is calculated from the matrix density and the apparent density, according to the following equation:

$$Closed porosity = 100. ( 1 - \frac{{ρ}_{apparent}}{{ρ}_{matrix}} )$$

The dissolution test was performed as follows. 30.0 g±0.1 g of water (milliQ grade) was placed in a 100 mL beaker (h=85 mm Ø=44 mm) with a magnetic stirrer (L=30 mm Ø=6 mm). The stirring rate was adjusted to 350 rpm and 1.000 g±0.002 g of powder was added in the solution. During the dissolution, the refractive index of the solution was registered each second until a plateau corresponding to complete dissolution was reached. Refractive index was measured using a FISO FTI-10 Fiber Optic Conditioner These experiments were performed at room temperature (23-25° C.).

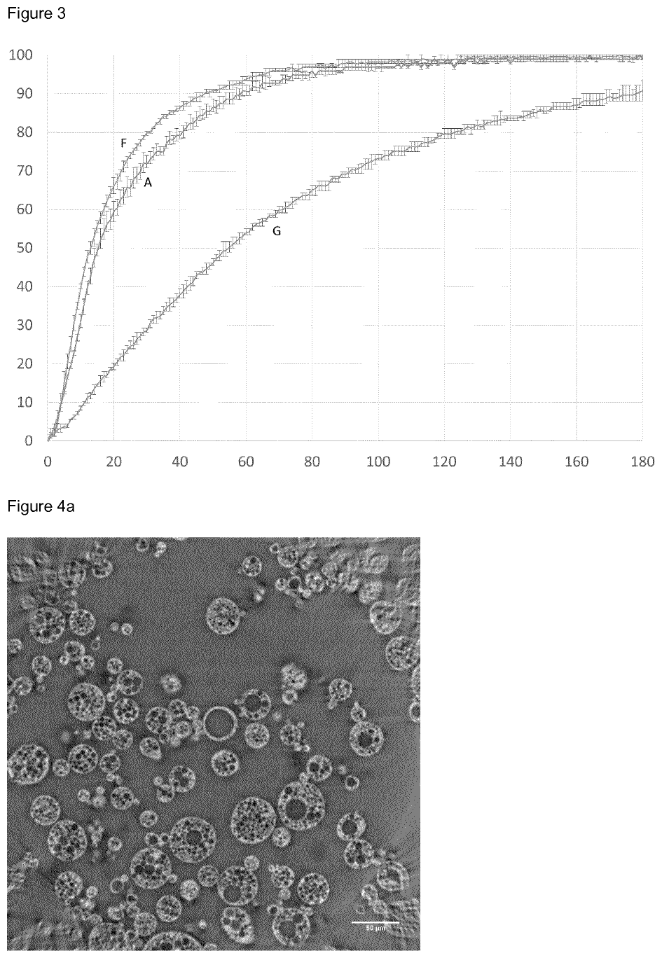

The result of varying composition is shown in FIG. 2. Powders with a lower proportion of sucrose dissolve more slowly. The result of varying the porosity is shown in FIG. 3. The powders with significant porosity (A and F) dissolved much more rapidly than the un-gassed sample (G).

### Example 3: Porous Structure

The porous structure of amorphous particles was examined using synchrotron radiation X-ray tomographic microscopy (SRXTM), at the TOMCAT beamline of the Swiss Light Source (SLS), Paul Scherrer Institut, Switzerland. The acquisition followed a standard approach with the rotation axis located in the middle of the field of view. Exposure time at 15 keV was 300 ms and 1,501 projections equi-angulary distributed over 180° were acquired.

Projections were post-processed and rearranged into corrected sinograms. Stacks of 2161 16 bits Tiff images (2560×2560 pixel) were generated with a resolution of 0.1625 μm per pixel.

Slice data were analysed and manipulated using Avizo 9.0.0 (https://www.fei.com/software/amira-avizo/) software for computed tomography.

The routine used for the measurement was the following. For each sample, 3 stacks of 500 images were analysed. After sub volume extraction, stacks of images were thresholded using an automatic routine to specifically select the matrix material and calculate its volume. Then the surface of each sample was estimated using the surface generation module of the software and the surface values were extracted. Normalized specific surface was calculated as the ratio of the matrix volume by the total material surface (external and pores).

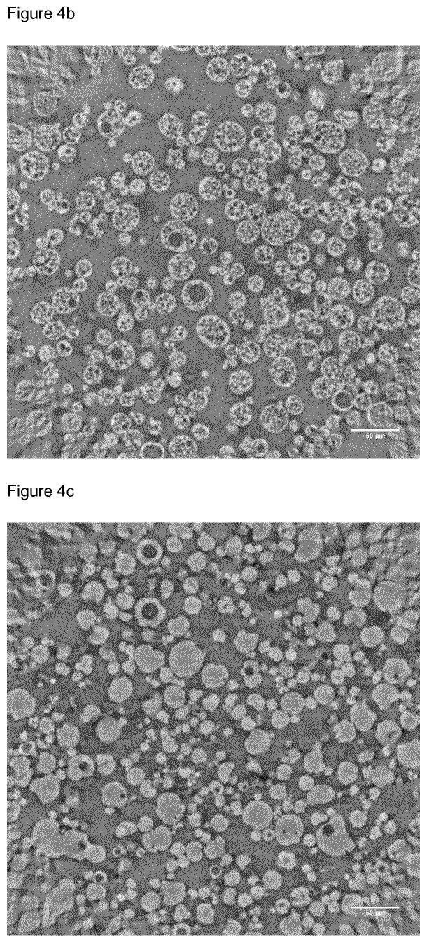

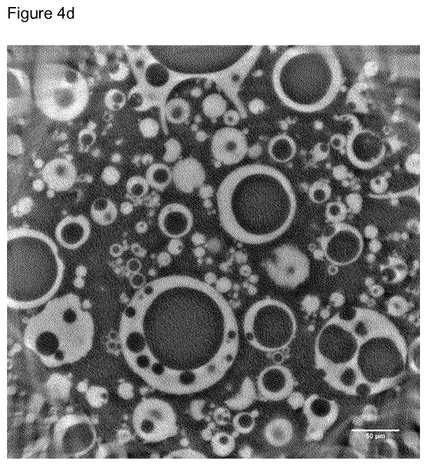

Powders with different levels of closed porosity (A, F and G from Example 5) were imaged, together with a powder (H) as a comparative example which did not contain a non-dairy protein. Powder H was prepared in a similar manner to that described in Example 1, except that the inlet solution contained 50% water, 25% sucrose and 25% of a 21 DE maltodextrin (Roquette) and carbon dioxide was used instead of nitrogen. Powder H had a closed porosity of 31% and a particle size D90 of 3.84 μm. The images are shown in FIG. 4a (A), FIG. 4b (F), FIG. 4c (G) and FIG. 4d (H). The calculated normalized specific surfaces (mean of three sets of 500 slices) were as follows:

| Powder | A | F | G | H |
|---|---|---|---|---|
| Normalized specific | 0.166 | 0.133 | 0.074 | 0.049 |
| surface (m⁻¹) | | | | |

As can be seen from the images, the porous structure of powders A and F comprise multiple small pores. The internal surface of these pores leads to a high normalized specific surface value. The normalized specific surface for sample F is lower than sample A, consistent with the measured lower closed porosity value. Sample G, where no gassing was applied, has a low porosity and a low normalized specific surface value. For sample H it can be seen that although it has a similar closed porosity value to sample F, the structure is very different, with large voids within the particles. Such a structure is physically weaker than multiple small pores, and if the outer walls of the particles are broken, no (or very little) porosity remains. Sample H has a correspondingly lower normalized specific surface value.

### Example 4: Preparation of Amorphous Porous Particles with Non-Dairy Proteins

Three non-dairy proteins from different origins (vegetable, carbohydrate, grains) were tested as components of amorphous porous powders.

Wheat gluten protein, pea protein and potato protein were used to prepare amorphous porous powders at a level of 3 wt. %. The other components were 60 wt. % sucrose and 37 wt. % Nutriose® (a plant-based fibre from Roquette). A further sample with pea protein was prepared where lactose was used as the bulking agent instead of Nutriose®. For comparison, a powder with 3 wt. % sodium caseinate, 60 wt. % sucrose and 37 wt. % Nutriose® was prepared. The components were dissolved in water at a total solids of 50% and spray dried with gas injection a described in Example 1. All variants were successfully produced with a throughput of 10-12 L/h.

Physical and chemical characterization of the powders was performed. Results of moisture, glass transition and water activity are presented below.

| | | Moisture | T_{g} | |
|---|---|---|---|---|
| | | [%] | [° C.] | a_{w} [−] |
| I | 60% Sucrose, 37% Nutriose ®, | 2.50 | 48.8 | 0.162 |
| | 3% NaCas | | | |
| J | 60% Sucrose, 37% Nutriose ®, | 2.59 | 49.2 | 0.147 |
| | 3% pea protein | | | |
| K | 60% Sucrose, 37% lactose, | 2.43 | 51.7 | 0.126 |
| | 3% pea protein | | | |
| L | 60% Sucrose, 37% Nutriose ®, | 2.11 | 54.1 | 0.114 |
| | 3% wheat gluten | | | |
| M | 60% Sucrose, 37% Nutriose ®, | 2.81 | 46.6 | 0.166 |
| | 3% potato protein | | | |

Results of particle properties are shown below.

Changing the surfactant (the protein) leads to changes in porosity. Pea protein, potato protein and wheat gluten protein provide high levels of closed porosity, although slightly lower than that obtained by sodium caseinate. The use the fibre Nutriose® seems to favour the formation of closed pores.

| | | Closed | |
|---|---|---|---|
| | Apparent | porosity | D90 |
| | density [−] | [%] | [μm] |
| I | 0.624 | 60.8 | 70.2 |
| J | 0.804 | 49.5 | 60.0 |
| K | 0.893 | 43.9 | 55.8 |
| L | 0.749 | 53.3 | 58.1 |
| M | 0.772 | 51.0 | 87.2 |

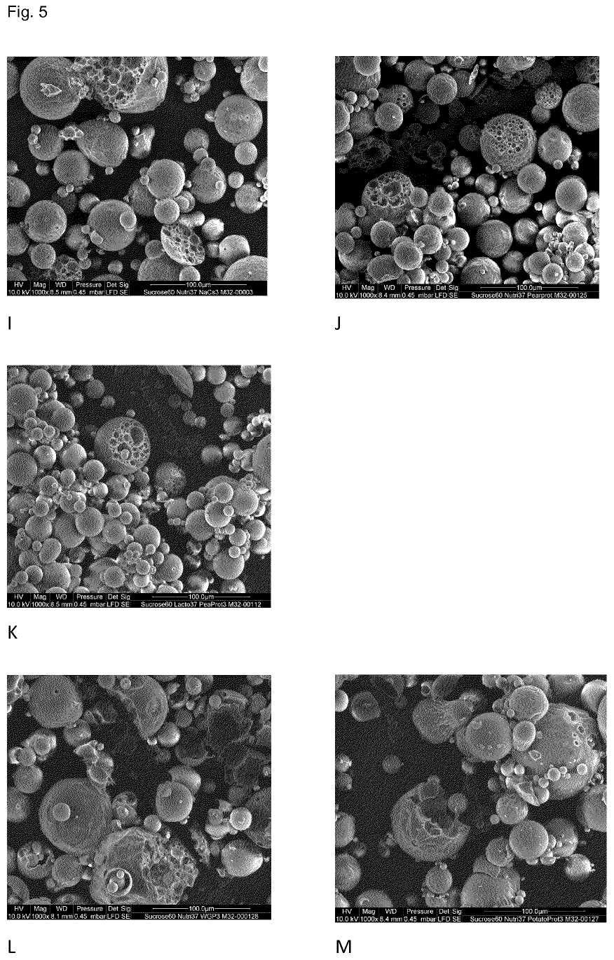

The microstructure of the particles was investigated by SEM analysis (FIG. 5). Samples can be distinguished by two main subgroups. First, we observe that particles containing sodium caseinate and pea protein have a comparable structure. Particle size is between 5-70 microns. They are highly aerated, of which we observe mainly small bubbles or air channels of approximatively 5-10 microns. Open porosity, defined by the presence of aeration on the external surface of the particles, is only limited.

The other subgroup comprise particles containing wheat gluten protein and potato protein. Open porosity is slightly higher, due to thinner particle walls. Internal porosity show larger bubbles or air channels and is, comparatively, much more chaotic. The observed particle size is also larger, with particles up to 100 microns being observed.

### Example 5: Preparation of Amorphous Porous Particles with Plant Milks

Plant milks were combined with maltodextrin (DE12-20) and sucrose so that, on a solids basis there was 5% plant milk, 35% maltodextrin and 60% sucrose. The mixtures were made up with water at a total solids level of 50% and spray dried with gas injection as in Example 1. All variants are successfully produced with a throughput of 10-12 L/h.

Physical and chemical characterization of the powders was performed. Results of moisture, glass transition and water activity are presented below.

| | | Moisture | T_{g} | |
|---|---|---|---|---|
| | | [%] | [° C.] | a_{w} [−] |
| N | 60% Sucrose, 35% maltodextrin, | 3.26 | 45.4 | 0.168 |
| | 5% Spelt milk | | | |
| O | 60% Sucrose, 35% maltodextrin, | 3.03 | 47.3 | 0.166 |
| | 5% Coconut milk | | | |
| P | 60% Sucrose, 35% maltodextrin, | 3.45 | 42.1 | 0.194 |
| | 5% Oat milk | | | |
| Q | 60% Sucrose, 35% maltodextrin, | 3.22 | 45.6 | 0.177 |
| | 5% Almond milk | | | |
| R | 60% Sucrose, 35% maltodextrin, | 3.40 | 43.2 | 0.187 |
| | 5% Rice milk | | | |
| S | 60% Sucrose, 35% maltodextrin, | 3.68 | 42.0 | 0.203 |
| | 5% Soya milk | | | |

Results of particle properties are shown below.

Changing the plant milk type leads to changes in porosity. All the variants were highly aerated and had a closed porosity greater than 35%.

| | | Apparent | Porosity | D90 |
|---|---|---|---|---|
| | | density [−] | [%] | [μm] |
| N | 60% Sucrose, 35% maltodextrin, | 0.866 | 45.20 | 89.6 |
| | 5% Spelt milk | | | |
| O | 60% Sucrose, 35% maltodextrin, | 0.845 | 46.55 | 335.9 |
| | 5% Coconut milk | | | |
| P | 60% Sucrose, 35% maltodextrin, | 0.956 | 39.51 | 256.4 |
| | 5% Oat milk | | | |
| Q | 60% Sucrose, 35% maltodextrin, | 0.980 | 38.02 | 75.1 |
| | 5% Almond milk | | | |
| R | 60% Sucrose, 35% maltodextrin, | 0.974 | 38.41 | 884.4 |
| | 5% Rice milk | | | |
| S | 60% Sucrose, 35% maltodextrin, | 0.747 | 52.73 | 81.6 |
| | 5% Soya milk | | | |

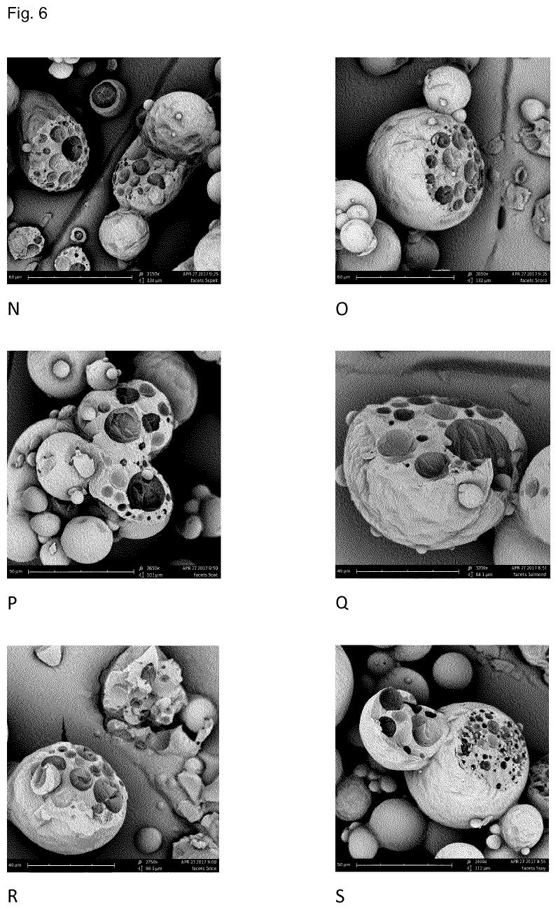

The microstructure of the particles was investigated by SEM analysis (FIG. 6). In terms of microstructure, they are all comparable. Particles size is in the order of magnitude of 70 microns, but their distribution is relatively poly-dispersed. Importantly, we observe that some powders are quite aggregated, which influences the D90 laser scattering measurements. Aeration is observed with several air bubbles or channels per particle, with a size of around 10 microns.

### Example 6: Kinetics of Dissolution of Amorphous Porous Particles with Plant Protein

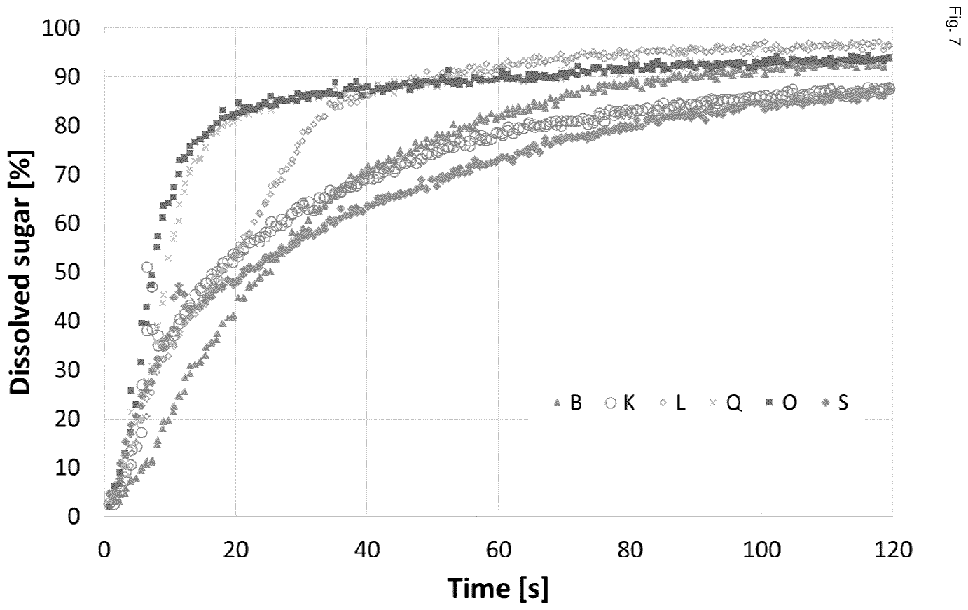

The kinetics of dissolution of five of the amorphous porous powders was measured and compared to that of a porous amorphous powder manufactured in the same manner, but with 60% sucrose and 40% skimmed milk (bovine) on a solids basis (Powder B from example 2). The samples assessed were lactose and pea (K), Nutriose® and wheat gluten (L), maltodextrin and almond milk (Q), maltodextrin and coconut milk (O) and maltodextrin and soya milk (S). The results are plotted in FIG. 7. The powder with sucrose, almond milk and maltodextrin has a much faster dissolution that that of sucrose and skimmed milk. Both powders having a similar particle size. Fast dissolution of a sweet tasting porous beverage powder which has moved to the top of the beverage allows it to create a gradient of sweet tastant in the reconstituted beverage before it is consumed.

### Example 7: Wettability Measurements

Contact angle measurements are performed in order to assess the wetting properties of the porous amorphous powders prepared with sucrose, maltodextrin and plant milks (samples N, O, P, Q, R, S) compared to a porous amorphous powder made from sucrose and skimmed milk (B). All the plant milk samples were found to be completely wetting (0° contact angle), whereas the porous amorphous powder with skimmed milk powder (SMP) presents a good wetting but is not completely wetting, with contact angle of 10°. This provides an indication that the plant milk samples have better wetting properties than the SMP sample, but it should be noted that wettability on a powder bed is dependent on the particle size and the roughness of the powder. Also, the amount of proteins is not equal between the variants.

In order to eliminate the influence of particle shape and amount of proteins, contact angle measurements were performed on thin films layers of 20% protein solutions. The values in the table below are the averages of 4 experiments.

| Sodium | Pea | Potato | Wheat gluten |
|---|---|---|---|
| caseinate | protein | protein | protein |
| 68.1° ± 3.0° | 57.3° ± 1.6° | 37.7° ± 1.6° | 8.9° ± 1.8° |

It can be observed that pure dissolved pea, potato and wheat gluten proteins have better wetting than sodium caseinate. Improved wetting of a powder is important when preparing a beverage. Powders with poor wettability do not disperse quickly into the beverage and can clump together into lumps which are difficult to dissolve.

### Example 8: Amorphous Porous Particles with Partially Aggregated Proteins

Liquid whole milk (total solids=12.5%) was heated at 65° C.-70° C. until reaching 45% total solids. The pH was adjusted to 6.1 with 5% citric acid solution and then a heat treatment at 95° C. was applied during 2 minutes in a high shear mixer. The concentrate was cooled at 65° C.-70° C. and then spray-dried with a low-pressure two-phase nozzle to form a dry powder comprising partially aggregated proteins. The particle size of the aggregates in the powder was measured as D[4,3]=8.31 microns.

Amorphous porous particles were produced as for Example 1, except that the skimmed milk powder was replaced by the powder comprising partially aggregated proteins obtained from whole milk powder as above.

### Example 9: Formation of Tastant Gradient on Beverage Powder Reconstitution

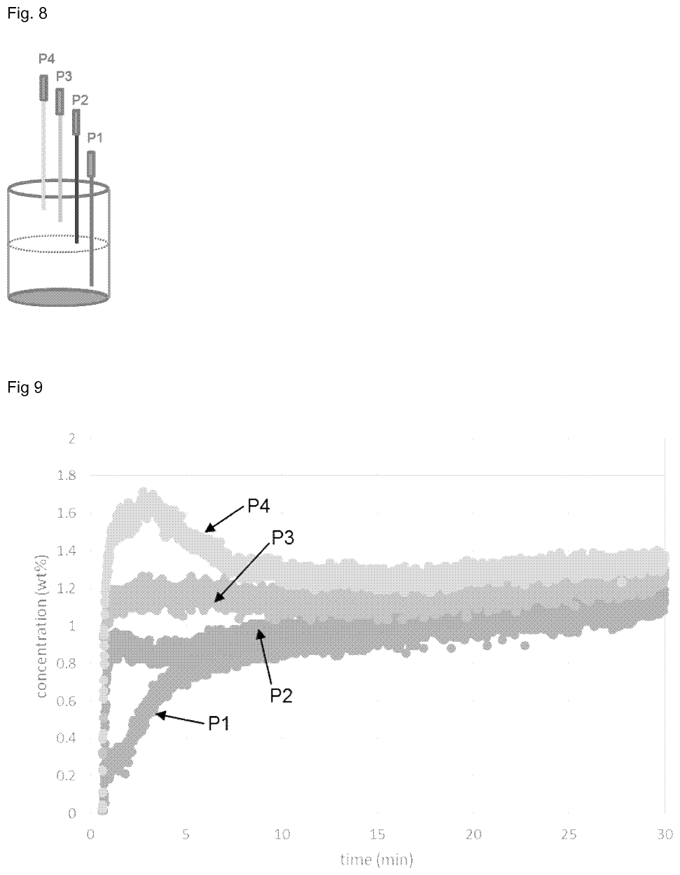

Sweet powders were added to a beaker of water and the concentrations obtained at different heights of the beaker were measured by refractive index. Four refractive index probes were fixed in a beaker at different heights, so that different layer concentrations could be measured (FIG. 8). The probes are numbered P1 (bottom) to P4 (top). The refractive index probes were connected to a FTI-10 universal fiber optic conditioner (FISO Technologies) and refractive indexes were recorded FISO Commander 2 software. Calibration of each sensor was preliminary performed by drawing a calibration curve at different sugar concentrations between 1% and 10% at room temperature (23-25° C.). For each test, the beaker was filled with 300 grams of Millipore filtered water before the sweet powder was added.

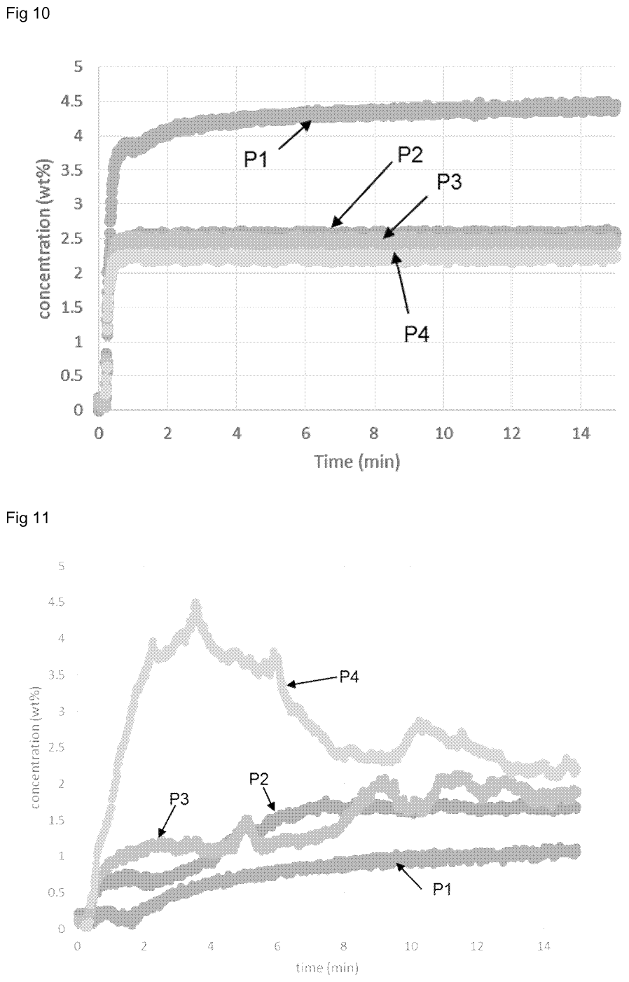

FIG. 9 shows the result of adding 5 g of a porous amorphous powder comprising 60% sucrose and 40% skimmed milk (Powder B from example 2) and briefly stirring forcefully. The refractive index measured by the probes at different heights is proportional to the sucrose concentration. The top sensor P4 records a higher concentration of sucrose, and this persists over 20 minutes. The ratio of concentration from top to bottom is given in the table below.

| | | | Predicted increase in sensory |
|---|---|---|---|
| Time after | | Concentration ratio | sweetness compared to |
| addition | | top to bottom | homogenous distribution |
| 1 | minute | 5.3 | +31% |
| 2 | minutes | 4.0 | +28% |
| 3 | minutes | 2.8 | +22% |
| 4 | minutes | 2.2 | +17% |
| 5 | minutes | 1.9 | +14% |

This is caused by the porous amorphous powder initially floating near or at the top of the beverage and dissolving rapidly to create a higher sucrose concentration at the top of the model beverage. The concentration gradient persists with time. For a consumer sipping the model beverage from the beaker they would experience a high initial sweetness perception. Increasing taste intensity at the start of a sip can be beneficial to the taste intensity of the beverage. This can be accurately modelled by taking into account the convection-diffusion of taste compounds from the bulk of the beverage to the sensory taste cells. Such a model was developed and predicts accurately data from variable tastant concentration and variable viscosity food products [Le Révérend et al., Food Funct., 4, 880-888 (2013)]. Using such a model to predict the effect of the obtained sucrose gradients yielded the increase in sensory sweetness shown in the table above.

For comparison, crystalline sucrose (20 g) was added to 300 g water with the same stirring as for Powder B. FIG. 10 shows that the highest sucrose concentration is found at the bottom of the beaker, with the concentrations at the three upper probe positions being similar to each other.

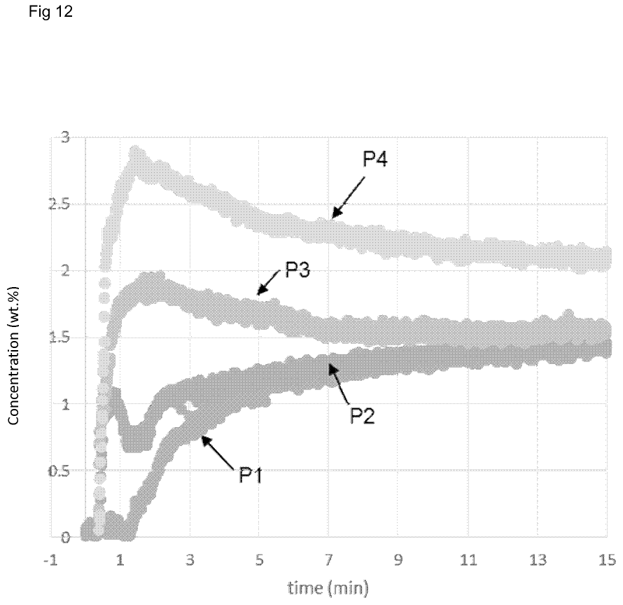

FIG. 11 shows the dissolution of 5 g of the powder from Example 8; amorphous porous particles with partially aggregated proteins. The dissolution was slower, with a strong foam formation. The stirring was reduced in intensity to avoid breaking the foam. For comparison, the dissolution of Powder B (5 g) was repeated with the same careful stirring (FIG. 12). FIG. 11 shows that the refractive index signal recorded by the upper probe (P4) was markedly higher than at the other probe positions for amorphous porous particles with partially aggregated proteins. This is believed to be due to the dissolved sucrose remaining “trapped” in the foam.

1. Beverage powder comprising water-soluble porous particles, the particles comprising a tastant and having an amorphous continuous phase comprising a soluble filler, wherein the particles have a closed porosity of between 10 and 80% and can float in water.

2. A beverage powder according to claim 1 wherein the tastant provides a sweet, salty or umami taste.

3. A beverage powder according to claim 1 further comprising partially aggregated proteins.

4. A beverage powder according to claim 3 wherein the partially aggregated proteins are selected from the group consisting of soy proteins, egg proteins, rice proteins, almond proteins, oat proteins, pea proteins, potato proteins, wheat proteins, milk proteins and combinations of these.

5. A beverage powder claim 1 wherein the surfactant is a plant or dairy protein.

6. A beverage powder according to claim 1 wherein the tastant is sucrose.

7. A beverage powder according to claim 1 wherein the amorphous continuous phase of the porous particles comprises sucrose and skimmed milk.

8. A beverage powder according to claim 1 wherein the amorphous continuous phase of the porous particles comprises sucrose, lactose, and partially aggregated milk protein.

9. A beverage powder according to claim 1 wherein the amorphous continuous phase of the porous particles comprises sucrose, maltodextrin and almond protein.

10. A beverage powder according to claim 1 wherein the tastant comprises sodium chloride and/or potassium chloride.

11. A beverage powder according to claim 10 wherein the amorphous continuous phase of the porous particles comprises maltodextrin, caseinate and dissociated sodium or potassium chloride.

12. A method to reduce the quantity of tastant in a beverage without adversely affecting the taste of the beverage comprising using a beverage powder to reduce the quantity of tastant in a beverage without adversely affecting the taste of the beverage.

13. Bottled beverage comprising;
a container comprising an opening for receiving a closure, the container containing a liquid beverage;
an ingredient release closure comprising a sealed compartment containing a beverage powder, a release mechanism for dispensing the beverage powder into the container, and an attaching member for attaching to the opening of the container;
the attaching member of the ingredient release closure attached to the opening of the container to form a bottled beverage; and
wherein the beverage powder comprises water-soluble porous particles which can float in water and which comprise a tastant.

14. A bottled beverage according to claim 13 wherein the tastant comprised within the beverage powder is absent from the liquid beverage.

15. (canceled)
